(19) United States
(12) Patent Application Publication
(10) Pub. No.: US 2015/0153246 A1
(43) Pub. Date: Jun. 4, 2015

(54) HORIZONTAL SHOCK WAVE TESTER

(71) Applicant: Agency for Defense Development, Daejeon (KR)

(72) Inventors: Changwon SHUL, Daejeon (KR); Taehyeong KIM, Daejeon (KR); Yoonjae KIM, Seoul (KR); Myungseog YANG, Daejeon (KR); Gyuseop LEE, Cheonan-si (KR)

(21) Appl. No.: 14/558,176

(22) Filed: Dec. 2, 2014

(30) Foreign Application Priority Data
Dec. 3, 2013 (KR) 10-2013-0149417

(51) Int. Cl. G01M 10/00

(52) U.S. Cl. CPC G01M 10/00

(57) ABSTRACT

Disclosed herein is a land based horizontal shock wave tester that simulates double shock waves generated in an underwater explosion. The horizontal shock wave tester includes a first shock wave generating unit, a second shock wave generating unit and a shock wave control unit. The first shock wave generating unit is installed at a predetermined position on a stationary mass on which a specimen is mounted. The second shock wave generating unit is provided to generate a secondary shock wave derived from a primary shock wave input from the first shock wave generating unit by collision of an impacting mass with the stationary mass. The shock wave control unit controls the second shock wave generating unit by using MR damper units so that a period and a magnitude of the stationary shock wave that vary depending on a period and a magnitude of the primary shock wave can be adjusted.

### CROSS REFERENCE TO RELATED APPLICATION(S)

This application claims the benefit of Korean Patent Application No. 10-2013-0149417, filed on Dec. 3, 2013, which is hereby incorporated by reference in its entirety into this application.

### BACKGROUND OF THE INVENTION

1. Technical Field

The present invention generally relates to shock wave testers for simulating shock waves applied to equipment by external shock and, more particularly, to a land based horizontal type shock wave tester that simulates shock waves generated in an underwater explosion and thus is able to evaluate shock survivability of a equipment.

2. Description of the Related Art

Generally, shipboards or submarines that are exposed to underwater explosion (UNDEX) environments are affected by shock waves. Due to such shock waves, equipment installed on shipboards or submarines is exposed to double pulse shock waves including, as shown in FIG. 1, a primary shock wave and a secondary shock wave that are applied in opposite directions. As shown in FIG. 1, a primary shock wave is defined by a maximum acceleration a₁ and time duration t₁ to maximum velocity V₁ transmitted to the specimen. While a secondary shock wave is defined by a maximum deceleration a₂ and a time duration t₂ to maximum velocity V₂ transmitted to the specimen.

With regard to such an underwater explosion, the equipment mounted on shipboard and submarine must be evaluated in terms of shock survivability to underwater explosions. Shock tests through real underwater explosions are conducted only within an extremely limited range because of many environmental problems, technical problems, high cost and time, and high danger. Given this, land based shock wave testers simulating a double pulse shock wave environment caused by an underwater explosion are typically used for evaluation of the shock survivability of an equipment.

Conventional shock wave testers are operated in such a way that shock is applied to a specimen and then shock waves are measured from a test table and a specimen. However, these are disadvantageous in that every time shock requirements are changed, parts provided on tester must be replaced with other parts. In addition, compared to controlling a primary shock wave primarily generated by first strike of impacting mass and deformed programmers, it is difficult to control a secondary shock wave derived from the primary shock wave.

### SUMMARY OF THE INVENTION

Accordingly, the present invention has been made keeping in mind the above problems occurring in the prior art, and an object of the present invention is to provide a horizontal shock wave tester configured such that an impacting mass collides with a stationary mass (a test table of the tester) provided with a specimen so as to simulate double shock waves, which are generated in an underwater explosion environment, and a secondary shock wave can be conveniently controlled by adjusting a second shock wave generating unit provided on a rear end of the stationary mass, whereby an underwater explosion environment for double shock wave tests can be more reliably simulated.

In order to accomplish the above object, the present invention provides a horizontal shock wave tester, including: a first shock wave generating unit installed at a predetermined position on a stationary mass on which a specimen is mounted; a second shock wave generating unit provided to generate a secondary shock wave derived from a primary shock wave input from the first shock wave generating unit by collision of an impacting mass with the stationary mass; and a shock wave control unit controlling the second shock wave generating unit so that a period and a magnitude of the stationary shock wave that vary depending on a period and a magnitude of the primary shock wave can be adjusted.

The second shock wave generating unit may be charged with fluid and be configured such that the period and the magnitude of the secondary shock wave are varied by varying a shearing force of the fluid.

The shock wave control unit may control current applied to the second shock wave generating unit and vary the period and the magnitude of the second shock wave generating unit.

The second shock wave generating unit may be disposed between the stationary mass and a fixed wall.

The second shock wave generating unit may include a second spring and an MR (magneto-theological) damper disposed between the stationary mass and a fixed wall.

The shock wave control unit may control current applied to the MR damper to control the second shock wave generating unit.

The second spring and the MR damper may be arranged in parallel to each other, and opposite ends of each of the second spring and the MR damper may be respectively connected to the stationary mass and the fixed wall.

The second spring and the MR damper may be arranged in series, and an auxiliary mass may be provided between the second spring and the MR damper.

The second spring may be disposed between the stationary mass and the movable auxiliary mass, and the MR damper may be disposed between the movable auxiliary mass and the fixed wall.

The primary shock wave may be generated by colliding the impacting mass with the first shock wave generating unit, and the first shock wave generating unit may be connected to a portion of the stationary mass that is opposed to the second shock wave generating unit connected to the stationary mass.

The first shock wave generating unit may comprise a spring fixed on the stationary mass.

The impacting mass may be accelerated by an actuator before colliding with the first shock wave generating unit.

### BRIEF DESCRIPTION OF THE DRAWINGS

The above and other objects, features and advantages of the present invention will be more clearly understood from the Wowing detailed description taken in conjunction with the accompanying drawings, in which:

FIG. 1 is a graph showing a double shock wave generated in an underwater explosion;

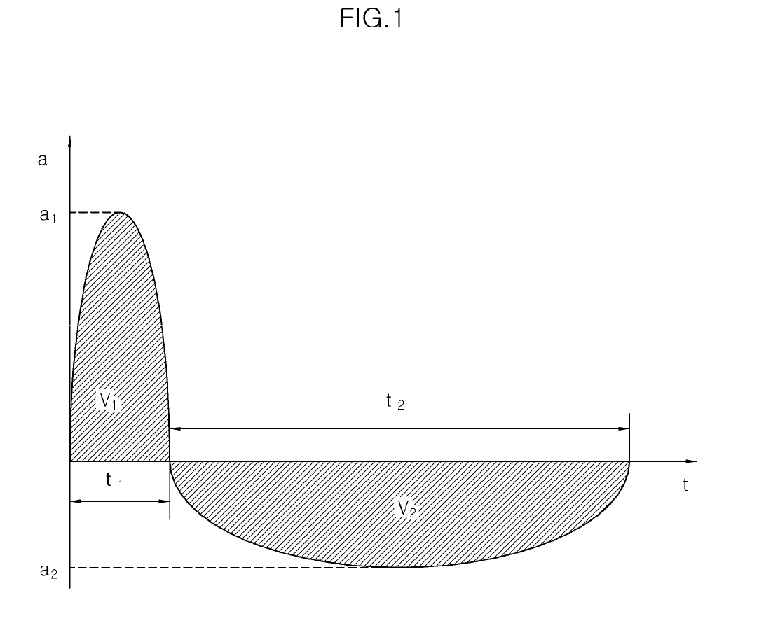

FIG. 2 is a schematic view illustrating the concept of a horizontal shock wave tester according to the present invention;

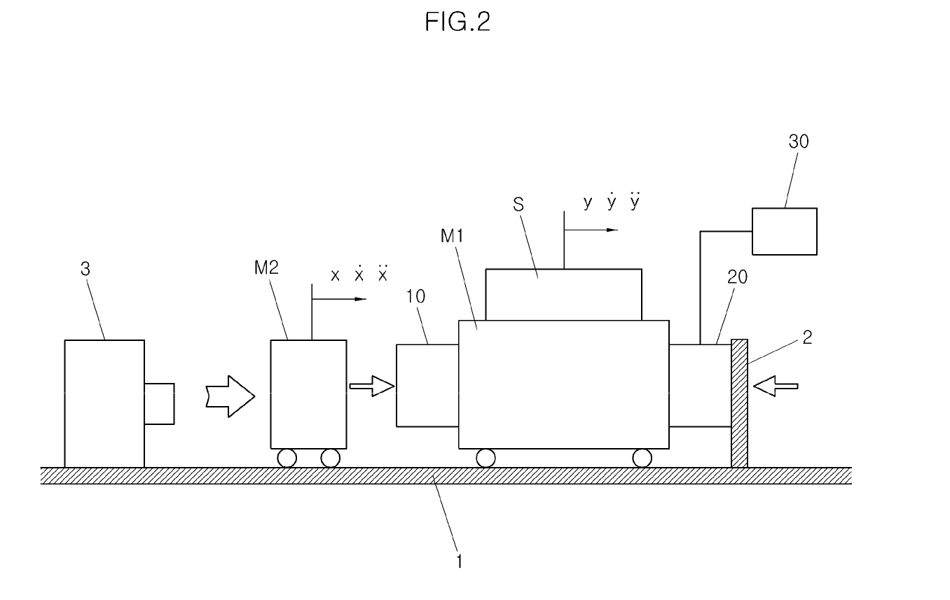

FIG. 3 is a schematic view illustrating an embodiment of the horizontal shock wave tester according to the present invention; and

FIG. 4 is a schematic view illustrating another embodiment of the horizontal shock wave tester according to the present invention.

### DESCRIPTION OF THE PREFERRED EMBODIMENTS

Hereinafter, a horizontal shock wave tester according to the present invention will be described in detail with reference to the accompanying drawings.

The horizontal shock wave tester according to the present invention includes: a first shock wave generating unit 10 installed on a first end of a second mass M2 on which a specimen S is disposed; a second shock wave generating unit 20 on which a secondary shock wave is generated by a primary shock wave input from the first shock wave generating unit 10; and a shock wave control unit 30 that controls the second shock wave generating unit to vary the period and magnitude of the secondary shock wave depending on the period and magnitude of the primary shock wave.

An impacting mass M1 that can be accelerated and moved and a stationary mass M2 that is in a stationary state each have a bogie shape and are arranged in the horizontal direction. A shock test is conducted in such a way that a shock wave is measured from the second mass M2 and the specimen S disposed on M2 when the impacting mass M1 horizontally collides with the stationary mass M2. Regarding the impacting mass M1 and the stationary mass M2 at an initial stage of the shock test, the impacting mass M1 is moved and accelerated while the stationary mass M2 is in a stationary state. After the impacting mass M1 collides with the stationary mass M2, the stationary mass M2 is moved within a predetermined displacement by a primary shock wave or a second shock wave. In the following description, for the sake of explanation, the impacting mass refers to the first mass M1, and the stationary mass refers to the second mass M2.

The first mass M1 that has been spaced apart from the second mass M2 is accelerated by a means such as an actuator 3 and collided with the second mass M2. The first mass M1 is on a base 1 so as to be movable. When the first mass M1 collides with the second mass M2, a first shock wave is generated.

The second mass M2 is also provided on the base 1 so as to be movable. The specimen S, from which shock waves generated by collision are measured, is installed on the second mass M2. If primary shock is applied to the second mass M2 by colliding the first mass M1 with the second mass M2, a primary shock wave generated by the primary shock and a secondary shock wave derived from the primary shock wave can be measured from the specimen S.

The first shock wave generating unit 10 is connected to the first end of the second mass M2. At the moment the first mass M1 collides with the second mass M2, the first shock wave generating unit 10 generates a primary shock wave resulting from collision between the first mass M1 with the second mass M2.

The second shock wave generating unit 20 is connected to a second end of the second mass M2 that is opposed to the first end of the second mass M2 on which the first shock wave generating unit 10 is installed. The second mass M2 is connected to a fixed wall 2 by the second shock wave generating unit 20. The second shock wave generating unit 20 functions to generate a secondary shock wave derived from the primary shock wave generated when the first mass M1 collides with the second mass M2.

The second shock wave generating unit 20 is preferably configured such that characteristics thereof are variable. In detail, the characteristics of the second shock wave generating unit 20 can be varied by the shock wave control unit 30, which will be explained later herein. For example, the second shock wave generating unit 20 may generate different secondary shock waves with respect to different primary shock waves. The second shock wave generating unit 20 may be controlled by the shock wave control unit 30 such that the magnitude and period of the secondary shock wave derived from the primary shock wave can be varied even under conditions of the same primary shock wave.

The shock wave control unit 30 controls the characteristics of the second shock wave generating unit 20 so that the magnitude and period of the secondary shock wave generated from. the second shock wave generating unit 20 can be varied. For instance, the shock wave control unit 30 is electrically connected to the second shock wave generating unit 20 and is configured such that the characteristics of the second shock wave generating unit 20 can be varied by controlling current applied from the shock wave control unit 30 to the second shock wave generating unit 20.

Hereinafter, embodiments of the horizontal shock wave tester according to the present invention will be described in detail.

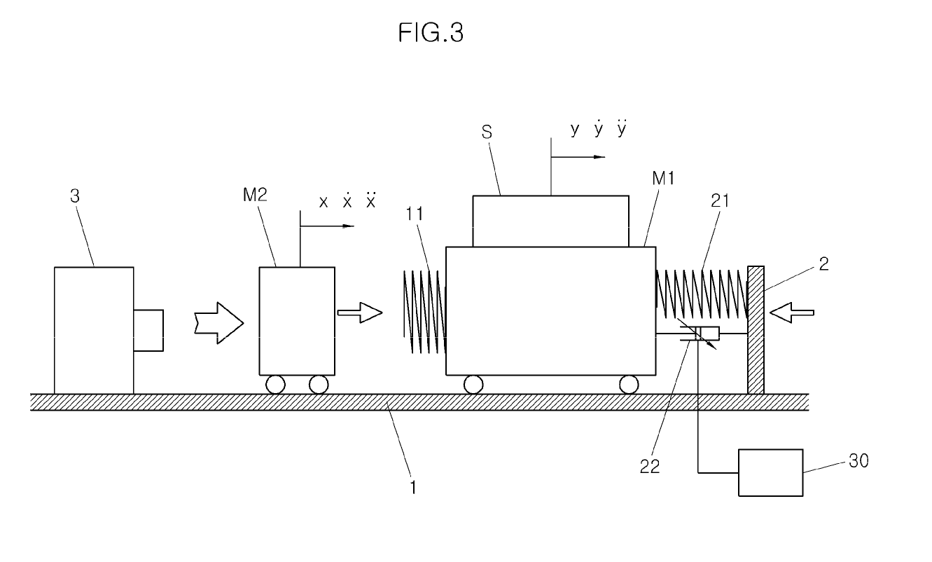

As shown in FIG. 3, a horizontal shock wave tester according to an embodiment of the present invention includes a first mass M1 and a second mass M2 that are horizontally arranged on a base 1. A first shock wave generating unit 10 is connected to a first end of the second mass M2 that faces the first mass M1. A second shock wave generating unit 20 is connected to a second end of the second mass M2 that is opposed to the first end of the second mass M2 to which the first shock wave generating unit 10 is connected. If the first mass M1 collides with the second mass M2, the first mass M1 moves by a displacement of x at a speed of \dot{x} and an acceleration of \ddot{x}, and the second mass M2 moves by a displacement of y at a speed of \dot{y} and an acceleration of ÿ.

The first shock wave generating unit 10 may be, as one example, a spring installed on the first end of the second mass M2. In this embodiment, a first spring 11 is installed on the first end of the second mass M2. When the first mass M1 accelerated by the actuator 3 or the like collides with the second mass M2, a primary shock wave is generated by the first spring 11 disposed between the second mass M2 and the first mass M1.

The second shock wave generating unit 20 functions to generate a secondary shock wave derived from the primary shock wave. As a detailed example, the second shock wave generating unit 20 may be a spring and an MR (magneto-rheological) damper 22. In this embodiment, a second spring 21 and the MR damper 22 are installed on the second end of the second mass M2 that is opposed to the first end of the second mass M2 on which the first shock wave generating unit 110 is installed, thus controlling a secondary shock wave.

The second shock wave generating unit 20 can be varied in characteristics by the shock wave control unit 30. Particularly, the second shock wave generating unit 20 sensitively reacts to high shock force. In this embodiment, the second shock wave generating unit 20 is configured such that the characteristics thereof are varied by adjusting current applied to the MR damper 22 under the control of the shock wave control unit 30. The MR damper 22 is a damper filled with MR fluid, which is varied in viscosity by shearing force when a magnetic field is applied thereto. The damping force of the MR damper 22 is expressed as a resultant force of the damping force derived from the viscosity of the MR fluid and the damping force generated by the shearing force of the MR fluid. The damping force derived from the viscosity of the MR fluid is substantially fixed because the viscosity of the MR fluid is constant. Therefore, the damping force of the MR damper 22 is varied by the shearing force of the MR fluid that varies depending on the magnitude of the magnetic field applied to the MR fluid. The MR damper 22 includes therein a core around which a coil is wound so that the MR damper 22 can be magnetized by external current applied thereto. The characteristics, that is, the damping force, of the MR damper 22 varies depending on variation of the current applied to the core.

Therefore, the secondary shock wave can be controlled in such a way that the damping force of the MR damper 22, that is, the characteristics of the second shock wave generating unit 20, is varied by controlling current applied from the shock wave control unit 30 to the MR damper 22 of the second shock wave generating unit 20.

The second shock wave generating unit 20 is installed between the second mass M2 and the fixed wall 2.

For example, the second spring 21 and the MR damper 22 that form the second shock wave generating unit 20 are arranged parallel to each other. Opposite ends of the second spring 21 are respectively connected to the. second mass M2 and the fixed watt 2. Also, opposite ends of the MR damper 22 are respectively connected to the second mass M2 and the fixed wall 2.

Hereinafter, the operation of the horizontal shock wave tester according to the present invention having the above-mentioned construction will be explained.

If the first mass M1 collides at a speed of \dot{x} with the second mass M2 having a bogie shape provided on the base 1 a primary shock wave is generated by the first shock wave generating unit 10.

The magnitude of the primary shock wave can be determined by the collision speed \dot{x}. The period of the primary shock wave can be controlled by the elastic modulus of the first shock wave generating unit 10, that is, the first spring 11.

Meanwhile, the period of the secondary shock wave can be controlled by the stiffness of the second spring 21 and the damping force of the MR damper 22 of the second shock wave generating unit 20. As mentioned above, the damping force FD of the MR damper 22 is expressed as a resultant force (FD=C₂\dot{y}+F_{MB}) of the damping force (C₂\dot{y}, C₂ denotes a viscosity coefficient of the MR fluid) derived from the viscosity of the MR fluid and the shearing force F_{MR} of the MR fluid. The damping force C₂\dot{y} of the MR damper 22 derived from the viscosity is proportional to the speed. \dot{y} of the second mass M2, in other words, is affected by the speed \dot{y} of the second mass M2. However, with regard to the shearing force of the MR fluid, even under the same conditions, in other words, even when the weight of the first mass M1, the weight of the second mass M2, the speed \dot{x} of the first mass M1, the elastic modulus of the first spring 11, the elastic modulus of the second spring 21 and the viscosity coefficient (C₂ of the MR fluid are the same, the characteristics of the second shock wave generating unit 20 can be varied by controlling current applied to the MR fluid. Thereby, the speed \dot{y} of the second mass M2 and the magnitude and period of the secondary shock wave can he controlled. Therefore, the same effect as that of semi-sine wave shock tests keeping with various real underwater explosion phenomena can be embodied.

Meanwhile, the second spring 21 and the MR damper 22 of the second shock wave generating unit 20 may he arranged in series,

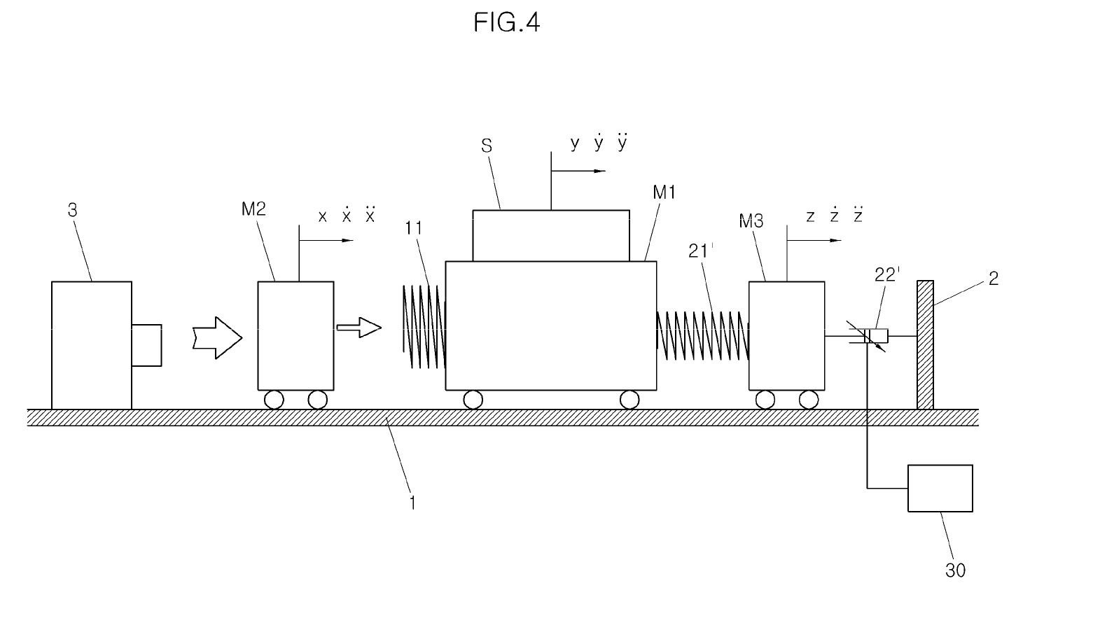

For example, as shown in FIG. 4, a second spring 21′ and an MR damper 22′ of the second shock wave generating unit may be arranged in series between the second mass M2 and the fixed wall 2.

Preferably, a third mass M3 that is an auxiliary mass is provided on the base 1 between the second spring 21′ and the MR damper 22′ so as to be movable. In this case, the second spring 21′ and the MR damper 22′ are respectively installed between the second mass M2 and the third mass M3 and between the third mass M3 and the fixed wall 2. More preferably, the second spring 21′ is disposed on a portion of the third mass M3 that is adjacent to the second mass M2, and the MR damper 22′ is disposed on a portion of the third mass M3 that is adjacent to the fixed wall 2. When the first mass M1 collides with the second mass M2, the third mass M3 moves by a displacement of z at a speed of ż and an acceleration of \ddot{z}.

Thereby, the period and magnitude of the secondary shock wave generated by the second shock wave generating unit can be controlled.

As described above, in a horizontal shock wave tester according to the present invention, characteristics of a second shock wave generating unit can be precisely controlled by controlling current applied, of a second spring and an MR damper of a shock wave control unit, to an MR damper. Furthermore, the magnitude and period of a secondary shock wave generated by the second shock wave generating unit can he diversified by precisely controlling current applied to the MR damper of the second shock wave generating unit.

As such, because the magnitude and period of a secondary shock wave generated by the second shock wave generating unit can be diversified, shock waves generated by various styles of real underwater explosions can be terrestrially simulated. Thereby, the shock resistance of real equipment can be evaluated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A horizontal shock wave tester, comprising:
a first shock wave generating unit installed at a predetermined position on a stationary mass on which a specimen is mounted;
a second shock wave generating unit provided to generate a secondary shock wave derived from a primary shock wave input from the first shock wave generating unit by collision of a movable mass with the stationary mass; and
a shock wave control unit controlling the second shock wave generating unit so that a period and a magnitude of the stationary shock wave that vary depending on a period and a magnitude of the primary shock wave can be adjusted.

2. The horizontal shock wave tester as set forth in claim 1, wherein the second shock wave generating unit is charged with fluid and is configured such that the period and the magnitude of the secondary shock wave are varied by varying a shearing force of the fluid.

3. The horizontal shock wave tester as set forth in claim 2, wherein the shock wave control unit controls current applied to the second shock wave generating unit and varies the period and the magnitude of the second shock wave generating unit.

4. The horizontal shock wave tester as set forth in claim 1, wherein the second shock wave generating unit is disposed between the stationary mass and a fixed wall.

5. The horizontal shock wave tester as set forth in claim 1, wherein the second shock wave generating unit comprises a second spring and an MR (magneto-theological) damper disposed between the stationary mass and a fixed wall.

6. The horizontal shock wave tester as set forth in claim 5, wherein the shock wave control unit controls current applied to the MR damper to control the second shock wave generating unit.

7. The horizontal shock wave tester as set forth in claim 6, wherein the second spring and the MR damper are arranged in parallel to each other, and
opposite ends of each of the second spring and the MR damper are respectively connected to the stationary mass and the fixed wall.

8. The horizontal shock wave tester as set forth in claim 6, wherein the second spring and the MR damper are arranged in series, and an auxiliary mass is provided between the second spring and the MR damper.

9. The horizontal shock wave tester as set forth in claim 8, wherein the second spring is disposed between the stationary mass and the movable mass, and the MR damper is disposed between the auxiliary mass and the fixed wall.

10. The horizontal shock wave tester as set forth in claim 1, wherein the primary shock wave is generated by colliding the impacting mass with the first shock wave generating unit, and the first shock wave generating unit is connected to a portion of the stationary mass that is opposed to the second shock wave generating unit connected to the stationary mass.

11. The horizontal shock wave tester as set forth in claim 10, wherein the first shock wave generating unit comprises a spring fixed on the stationary mass.

12. The horizontal shock wave tester as set forth in claim 10, wherein the movable mass is accelerated by an actuator before colliding with the first shock wave generating unit.
